(19) United States
(12) Patent Application Publication
(10) Pub. No.: US 2026/0359665 A1
(43) Pub. Date: Nov. 12, 2026

(54) SYSTEMS AND METHODS FOR AUTOMATICALLY GENERATING DATA OBJECT FROM USER PROMPT

(71) Applicant: FMR LLC, Boston, MA (US)

(72) Inventors: Ray ZHANG, Winchester, MA (US); Christopher James MURRAY, Fairfield, CT (US); Shivam Anandkumar MODI, Jersey City, NJ (US); Tricia Boffoli HASKINS, Medfield, MA (US); Jim LAU, Upton, MA (US); Manish Pramod WORLIKAR, Flower Mound, TX (US); Andrew BRZEZINSKI, Chestnut Hill, MA (US)

(21) Appl. No.: 19/200,972

(22) Filed: May 7, 2025

(51) Int. Cl. G06N 5/01

(52) U.S. Cl. CPC G06N 5/01

(57) ABSTRACT

Systems and methods are described for automatically generating a data object based on a user prompt. More specifically, a user may request to generate a data object by providing instructions in the form of a prompt and specifying a particular application programming interface (API). Upon receiving the user instructions, an API schema corresponding to the particular API is retrieved. A system prompt is generated based on the user prompt and the API schema. A data object is generated based on the system prompt.

### TECHNICAL FIELD

This application relates generally to systems and methods, including computer program products, for automatically generating data objects from a user prompt.

### BACKGROUND

Existing tools for generating sample payloads of application programming interface (API) requests from schema definitions typically employ heuristic approaches. These tools iterate through schema elements and randomly generate values based on the schema type. The resulting sample can be one of hundreds or thousands of scenarios, which may be invalid or irrelevant. Additionally, traditional tools do not utilize the detailed descriptions provided in API schemas, which can lead to suboptimal payload generation. Therefore, what is needed is a process to generate payloads that accurately conform to a user's intent.

### SUMMARY

The present disclosure, in one aspect, a computing system for generating a sample data object that is associated with an application programming interface (API) request, the system comprising memory for storing computer-executable instructions and a processor that executes the computer-executable instructions to: receive user instructions from a user to generate a data object associated with an API request, wherein the user instructions include a particular API associated with the API request and a user prompt, which is in a natural language format, that specifies a scenario from which to generate the data object, and wherein the data object includes instructions for facilitating at least one of the retrieval of data from or the execution of one or more tasks on a server computing device; generate, via a first machine learning model, a relevance value based on at least one of the user prompts and an API schema, corresponding to the particular API, that is retrieved from a database, wherein the relevance value indicates whether a data object is capable of being generated based on the user prompt and the API schema; generate a system prompt, which is in a natural language format, that specifies a procedure for a machine learning model to perform when generating the data object, wherein the system prompt is generated after determining that the relevance value reaches a predetermined relevance threshold, and wherein the system prompt is generated by modifying a system prompt template to include the user prompt and the API schema; generate, via a second machine learning model, the data object based on the system prompt, wherein the data object includes one or more data object items, and wherein, in a case that the second machine learning model fails to generate a value for a specific data object item based on at least one of the user prompt and the API schema, the second machine learning model generates a default value for the specific data object item; and display the data object before the user on a user interface, wherein the one or more data object items are modifiable by the user via the user interface.

The data object items are displayed on the form as key-value pairs, wherein each of the keys in the key-value pairs are unmodifiable, and wherein each of the values in the key-value pairs are modifiable by the user. The schema includes at least one of JavaScript Object Notation (JSON), Yet Another Markup Language (YAML), and Web Service Description Language (WSDL). In a case that the schema is JSON, the data object may be converted into a Postman collection which is configured to be downloaded by the user via the user interface. After the API schema is retrieved from the database, the computer executable instructions cause the processor to perform further operations to: perform a dereferencing process in which a dereference API schema is generated from the API schema by replacing each reference line in the API schema with a corresponding definition. The computer executable instructions cause the processor to perform further operations to: perform a converting process to generate a converted API schema by converting the dereference API schema from a first format to a second format, wherein the converted API schema is utilized by at least one of the first machine learning model to generate the relevance value and the second machine learning model to generate the data object. In a case that the specific data object item includes a type of integer, then the default value is zero, wherein, in a case that the specific data object item includes a type of Boolean, then the default value is false, and wherein, in a case that the specific data object item includes any other type, the default value is a string having the pound (#) character.

The present disclosure, in another aspect, features a non-transitory computer-readable medium including computer-executable instructions that, when executed by a computing device, causes the computing device to: receive user instructions from a user to generate a data object associated with an API request, wherein the user instructions include a particular API associated with the API request and a user prompt, which is in a natural language format, that specifies a scenario from which to generate the data object, and wherein the data object includes instructions for facilitating at least one of the retrieval of data from or the execution of one or more tasks on a server computing device; generate, via a first machine learning model, a relevance value based on at least one of the user prompts and an API schema, corresponding to the particular API, that is retrieved from a database, wherein the relevance value indicates whether a data object is capable of being generated based on the user prompt and the API schema; generate a system prompt, which is in a natural language format, that specifies a procedure for a machine learning model to perform when generating the data object, wherein the system prompt is generated after determining that the relevance value reaches a predetermined relevance threshold, and wherein the system prompt includes the user prompt and the API schema; generate, via a second machine learning model, the data object based on the system prompt, wherein the data object includes one or more data object items, and wherein, in a case that the second machine learning model fails to generate a value for a specific data object item based on at least one of the user prompt and the API schema, the second machine learning model generates a default value for the specific data object item; and display the data object before the user on a user interface, wherein the one or more data object items are modifiable by the user via the user interface.

The system prompt includes one or more examples that are associated with the schema corresponding to the particular API, and wherein the system prompt includes formatting instructions that instruct the second machine learning model to generate the data object based on a structure of the one or more examples. The system prompt further includes one or more event instructions that guide the second machine learning model on how to handle a specific event in case that the second machine learning model encounters the specific event when generating the data object. The system prompt further includes security instructions that instructs the second machine learning model to focus on portions of the user prompt that is relevant to the scenario and to disregard portions that are associated with system-level prompting instructions. The system prompt further includes output instructions that instruct the second machine learning model to output the data object by itself without additional content. In a case that the relevance value is less than a predetermined threshold, the user is informed that the data object cannot be generated based on the user prompt. The data object is validated based on the API schema, and wherein, in a case that the data object fails to conform to a framework of the API schema, the user is informed, via the user interface, that an error has occurred.

The present disclosure, in another aspect, features a computerized method for generating a sample data object that is associated with an application programming interface (API) request, the method comprising: receiving user instructions from a user to generate a data object associated with an API request, wherein the user instructions include a particular API associated with the API request and a user prompt, which is in a natural language format, that specifies a scenario from which to generate the data object, and wherein the data object includes instructions for facilitating at least one of the retrieval of data from or the execution of one or more tasks on a server computing device; generating, via a first machine learning model, a relevance value based on at least one of the user prompts and an API schema, corresponding to the particular API, that is retrieved from a database, wherein the relevance value indicates whether a data object is capable of being generated based on the user prompt and the API schema; generating a system prompt, which is in a natural language format, that specifies a procedure for a machine learning model to perform when generating the data object, wherein the system prompt is generated after determining that the relevance value reaches a predetermined relevance threshold, and wherein the system prompt is generated by modifying a system prompt template to include the user prompt and the API schema; generating, via a second machine learning model, the data object based on the system prompt, wherein the data object includes one or more data object items, and wherein, in a case that the second machine learning model fails to generate a value for a specific data object item based on at least one of the user prompt and the API schema, the second machine learning model generates a default value for the specific data object item; and displaying the data object before the user on a user interface, wherein the one or more data object items are modifiable by the user via the user interface.

The API request is formatted according to Hypertext Transfer Protocol (HTTP), in which the API request includes a uniform resource locator (URL), an HTTP method, a header, and a body. The HTTP method includes at least one of GET, POST, PUT, and DELETE, and wherein the data object is a payload within the header or body of the API request. The user instructions specify a particular URL that corresponds to an endpoint of the API request and a particular HTTP method, and wherein the system prompt includes the particular URL and the particular HTTP method. The first machine learning model or the second machine learning model is at least one of a language model and a large language model (LLM). In a case that the first machine learning model or the second machine learning model is an LLM, the first machine learning model or the second machine learning model includes at least one of tGPT-4o (Omni), GPT-4 32 k, Claude-35 Sonnet, Claude-3 Sonnet, and Claude-3 Haiku.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for generating a data object from a user prompt.

FIG. 2 is a flow diagram of a computerized method for generating a data object.

FIG. 3 is an example diagram of a user interface that is configured to receive instructions from a user so as to generate the data object.

FIG. 4 is an example diagram of a portion of an API schema that is relevant to a user prompt in the user instruction.

FIG. 5 is an example diagram of a process for performing dereferencing and converting a portion of the API schema.

FIG. 6 is an example diagram of a process that is an abstract representation of a structure of a system prompt.

FIG. 7 is an example diagram of a user interface that displays the data object before the user.

FIG. 8 is an example diagram of multiple examples of user prompts and the corresponding data objects that were generated from such user prompts.

FIG. 9 is a diagram of an illustrative computing system.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools are discussed herein to facilitate the invention(s) disclosed herein. It should be appreciated by those skilled in the art that any one or more of such tools may be embedded in the application and/or in any of various other ways, and thus while various examples are discussed herein, the inventive aspects of this disclosure are not limited to such examples described herein.

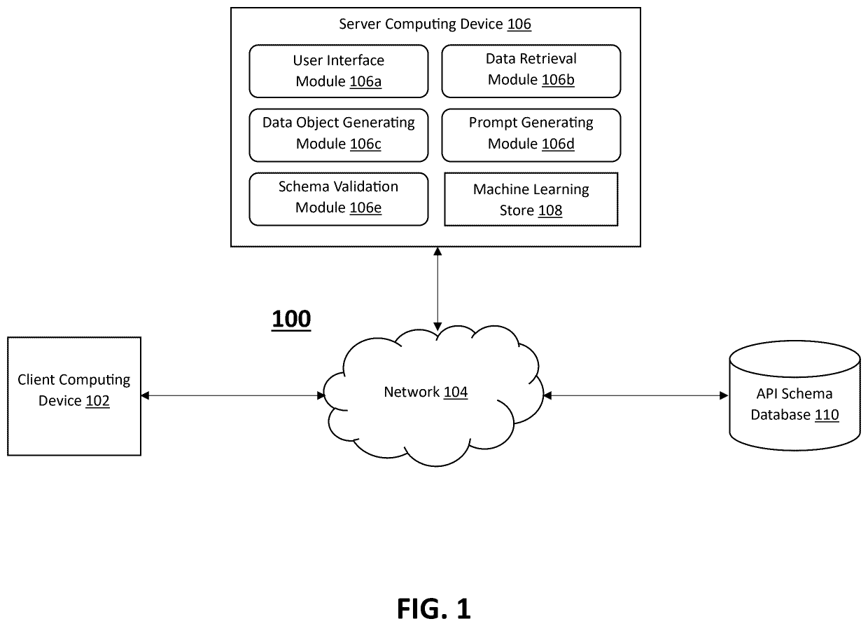

FIG. 1 is a block diagram of a system for 100, which includes a client computing device 102, a server computing device 106, and an application programming interface (API) schema 110 all of which are capable of communicating with each other via a communication network 104.

The client computing device 102 can be coupled to a display device (not shown), such as a monitor, display panel, or screen. For example, client computing device 102 can provide a graphical user interface (GUI) via the display device to a user of corresponding device that presents output resulting from the methods and systems described herein and receives input from the user for further processing. Further, the client computing device 102, may include one or more applications that provide additional functionality to the client computing device 102. For example, the client computing device 102 may include a browser application that allows access to the services provided by devices on system 100, via a website, which can be reached by entering a uniform resource locator (URL). Exemplary client computing device 102 include but is not limited to desktop computers, laptop computers, tablets, mobile devices, smartphones, smart watches, Internet-of-Things (IoT) devices, and internet appliances. It should be appreciated that other types of client computing devices that are capable of connecting to components of the system 100 can be used without departing from the scope of invention. Although FIG. 1 depicts a single client computing device 102, it should be appreciated that system 100 can include any number of client computing devices 102.

The communication network 104 can be a local area network, a wide area network, a cellular network, or any type of network such as an intranet, an extranet (for example, to provide controlled access to external users, for example through the Internet), a private or public cloud network, the Internet, etc., or a combination thereof. In addition, the communication network 104 preferably uses TCP/IP (Transmission Control Protocol/Internet Protocol), but other protocols such as SNMP (Simple Network Management Protocol) and HTTP (Hypertext Transfer Protocol) can also be used. In some embodiments, the communication network 104 is comprised of several discrete networks and/or sub-networks (e.g., cellular to Internet).

The server computing device 106 is a device including specialized hardware and/or software modules that execute on a processor and interact with memory modules of the server computing device 106, to transmit data to other components of the system 106, and to receive data from other components of the system 100, as described herein. The server computing device 106 includes several systems, frameworks, stores, and computing modules that execute on one or more processors of the server computing device 106. For example, the server computing device 106 includes a user interface module 106a, a data retrieval module 106b, a data object generating module 106c, a prompt generating module 106d, a schema validation module 106e, and a machine learning store 108 (which can store all types of machine learning models, such as classification type machine learning model(s), regression type machine learning model(s), support vector machines (SVM) machine learning model(s), ensemble method machine learning model(s), neural network model(s), recurrent neural networks (e.g., long short term memory), deep learning model(s), or (large) language model(s)). In some embodiments, the user interface module 106a, the data retrieval module 106b, the data object generating module 106c, the prompt generating module 106d, the schema validation module 106e, and the machine learning store 108 are specialized sets of computer software instructions programmed onto one or more dedicated processors in server computing device 106 and can include specifically-designated memory locations and/or registers for executing the specialized computer software instructions.

Although the user interface module 106a, the data retrieval module 106b, the data object generating module 106c, the prompt generating module 106d, the schema validation module 106e and the machine learning store 108 are shown in FIG. 1 as executing within the same server computing device 106, in some embodiments the functionality of the user interface module 106a, the data retrieval module 106b, the data object generating module 106c, the prompt generating module 106d, the schema validation module 106e, and the machine learning store 108 can be distributed among a plurality of server computing devices. As shown in FIG. 1, the server computing device 106 allows the user interface module 106a, the data retrieval module 106b, the data object generating module 106c, the prompt generating module 106d, the schema validation module 106e, and the machine learning store 108, to communicate with each other in order to exchange data for the purpose of performing the described functions.

It should be appreciated that any number of computing devices, arranged in a variety of architectures, resources, and configurations (e.g., cluster computing, visual computing, cloud computing) can be used without departing from the scope of the invention. Exemplary functionality of the user interface module 106a, the data retrieval module 106b, the data object generating module 106c, the prompt generating module 106d, the schema validation module 106e, and the machine learning store 108 are described in detail below.

The API schema database 110 is a computing device (or, in some embodiments, may be a set of computing devices) that is configured to provide, receive and store various types of data associated with one or more application programming interface (API) schemas. More specifically, the API schema database 110 may store one or more different types of API schemas (e.g., Open API, etc.). An API may allow one or more software applications (or components) to communicate with each other using a set of definitions and protocols, thereby permitting the applications to share data and access functionalities without needing to know the internal details of each other's systems.

The API schema includes documentation that describes the structure or format of data that are exchanged between the two software applications. More specifically, the API schema specifies rules for how requests and/or responses is to be formatted, expected data types, and any constraints on the data. For example, the API schema may outline the structure of the data being sent and received (e.g., in formats such as JavaScript Object Notation (JSON), Extensible Markup Language (XML), Yet Another Markup Language (YAML), or Web Service Description Language (WSDL), etc.). In another example, the API schema may indicate one or more fields (or properties) within the data, the names of the fields, the data types of the fields (e.g., string, integer, Boolean, etc.), and whether the field is required or optional. In yet another example, the API schema may also indicate the expected format of requests that the clients send to the server (e.g., HTTP methods such as GET, POST, PUT, DELETE), endpoints, and any required parameters. In a further example, the API schema may also indicate the format of the response that is sent back to the client, including the HTTP status codes and the response body. In yet a further example, the API schema may also include rules for validating the data being exchanged between the client and the server, thereby ensuring the data conforms to the expected format (and/or constraints).

### Example Routine for Generating a Data Object

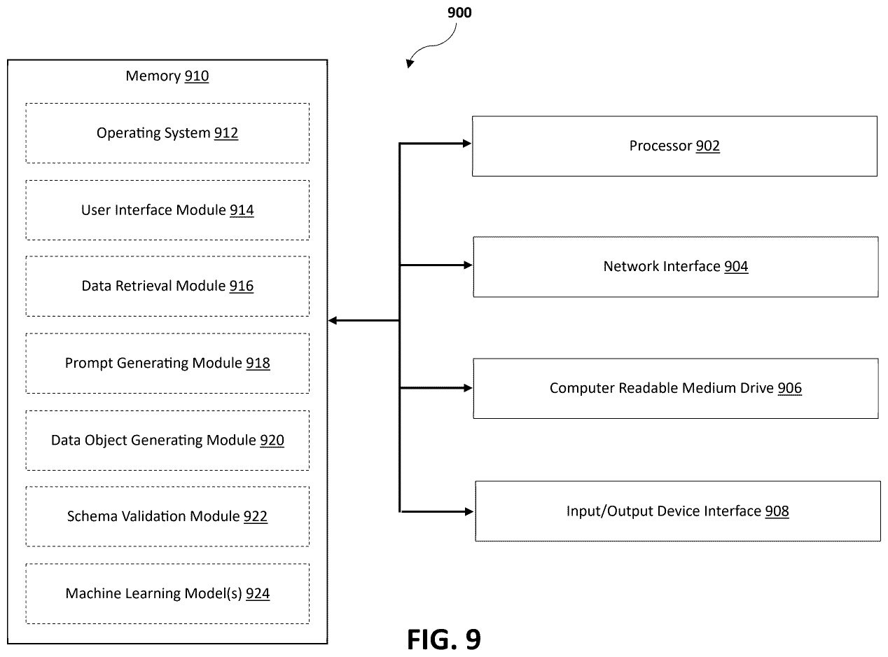

When a routine described herein (i.e., 200) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 900 shown in FIG. 9, and executed by one or more processors. In some embodiments, the routine 200 or portions thereof may be implemented on multiple processors, serially or in parallel.

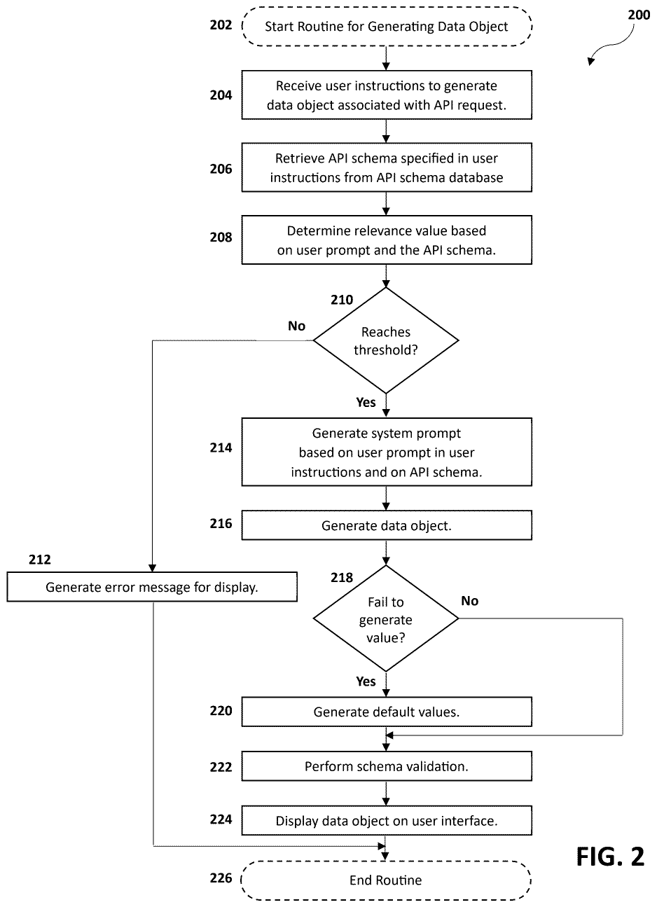

FIG. 2 illustrates example routine 200 (beginning at block 202) for generating a data object, that is performed, for example, by the server computing device 106. For example, the data object may include instructions for facilitating at least one of the retrieval of data from or the execution of one or more tasks on a server computing device. At block 302, the user interface module 106a receives instructions to generate a data object associated with an application programming interface (API) request. As discussed previously, an API may allow one or more software applications (or components) to communicate with each other using a set of definitions and protocols, thereby permitting the applications to share data and access functionalities without needing to know the internal details of each other's systems.

More specifically, each software application may include an API component, which may accept incoming requests (e.g., from another application) in a predetermined format (e.g., JavaScript Object Notation (JSON), Extensible Markup Language (XML), Yet Another Markup Language (YAML), or Web Service Description Language (WSDL), etc.). Consequently, the API component may not accept (e.g., refuse or delete) incoming requests that are not in the predetermined format specified by the API (e.g., API component deletes an incoming request in the YAML format because the API component accepts incoming requests in the JSON format).

In some embodiments, when the API component of a response application receives an incoming request (e.g., formatted according to Hypertext Transfer Protocol (HTTP)) from a requesting application, the API component may, after validating the format of the request data (e.g., JSON) in the incoming request, extract the relevant data from the request data in the incoming request or, in the alternative, transform the request data in the incoming request into a format processable by the response application (e.g., from a first format to a second format). The API component then transmits the extracted or transformed request data to the response application for processing. In some embodiments, the response application may be programmed to accept the incoming requests as is (i.e., provided that the incoming requests are in the predetermined format acceptable by the API component). In other words, no extraction or transformation is performed on the request data in the incoming request. The request data in the incoming request is simply transmitted by the API component to the response application without being modified.

After processing the request data in the incoming request, the response application may generate response data in response to the request. Next, the response application may transmit the response data to the API component. Then, the API component may transform the response data into the same format as the request data (e.g., JSON). Alternatively, the API component may not need to transform the response data because the response data is already in the proper format (e.g., JSON). Afterwards, the API component may then generate an outgoing response (e.g., in HTTP) which includes the response data (e.g., in JSON). Then, after generating the outgoing response, the API component may transmit the outgoing response to the requesting application.

In some embodiments, an API architecture can include a client and a server, in which the client may be the requesting application sending requests, and the server may be the response application sending a response (e.g., to the request). For example, the client may send requests to the server as request data. The server uses this request data to start internal functions and returns response data back to the client. The aforementioned client-server architecture may be implemented using Representational State Transfer (REST). REST defines a set of functions (e.g., GET, POST, PUT, DELETE, etc.) that clients can use to access server data (e.g., transmitted as response data). For example, the clients and servers can communicate (e.g., exchange data) using HTTP. It should be noted that REST is stateless, since the servers do not save request data received from the client between requests. In some embodiments, incoming requests from the client to the server are similar to URLs that are entered in a browser to access a website. In some embodiments, the outgoing response from the server is plain data, without the typical graphical rendering of a web page.

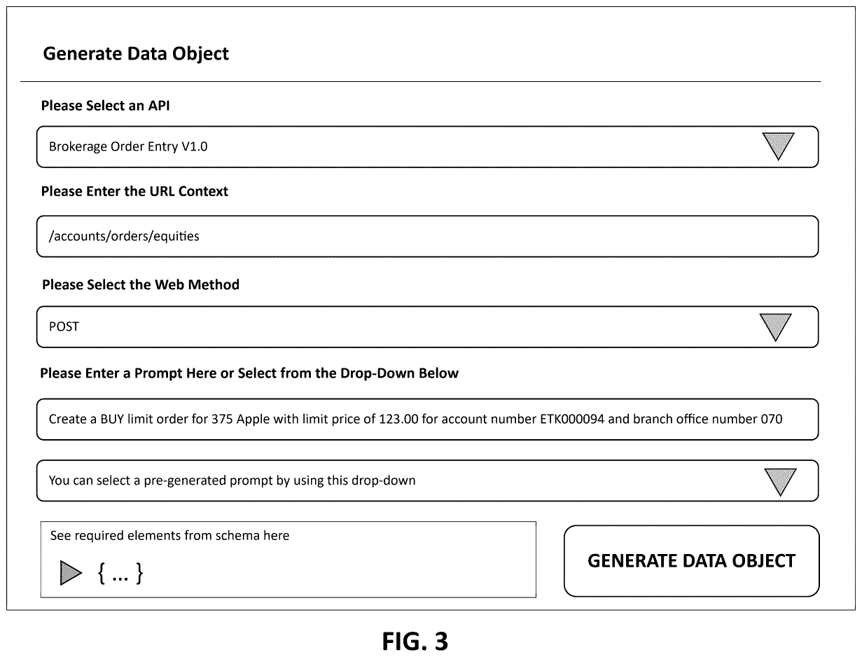

As shown in FIG. 3, a user may be shown a user interface that allows the user to generate a data object by generating user instructions (e.g., entering data into one or more fields in the user interface). For example, the user may select an API from which to generate the data object (e.g., “Please Select an API”). Such selection may be facilitated via a drop-down menu, which includes one or more predetermined API from which the user can select (e.g., “Brokerage Order Entry V1.0). Further, the user may also enter the Uniform Resource Locator (URL) context (e.g., “Please Enter the URL context”). The URL specifies the exact location of the API on, for example, a server (e.g., endpoint of the API request). In other words, the URL is what allows a requesting application to determine where to transmit the request.

Moreover, the user may also select a web method (e.g., GET, POST, PUT, DELETE, etc.) associated with the request. As discussed previously, web (or HTTP) methods are used to indicate the action a requesting application (e.g., client) is requesting the response application (e.g., server) to perform. Each web method maps each corresponding to a specific operation (e.g., creating, reading, updating, or deleting a data) that allows the client to interact with the server to create, retrieve, update, and delete data (e.g., resources) in the server. The GET operation is used to retrieve resources from the server (e.g., fetching a web page). The POST operation is used to send data to a server to create a new resource (e.g., submitting a form or uploading a file). The PUT operation is used to update or replace an existing resource. The DELETE operation is used to remove a resource from a server.

In short, an incoming (API) request (e.g., from a client to a server) may include a web method that specifies what kind of general action (e.g., operation) that the client is requesting the server perform. The client is capable of specifying further information in connection with the general action via the request data. More specifically, such request data may include instructions for facilitating at least one of the retrieval of data from or the execution of one or more tasks on a server computing device. For example, the client may submit a form (e.g., POST) that is for registering a bank account for a user, in which the registration includes personal information about the user (e.g., request data includes the registration action and the personal information of the user).

In addition, the user may also enter a user prompt (e.g., “Create a BUY limit order for 375 Apple with limit price of 123.00 for account number ETK000094 and branch office number 070”) that may, for example, be in a natural language format. The user prompt may be a prompt, which is an input or instruction that is provided (e.g., by a user) to a machine learning model (e.g., a large language model (LLM)) that guides the machine learning model to generate a specific response or output based on the information provided in the instruction. For example, a prompt may include a question, statement, or command. In another example, a prompt may be in a natural language format. It should be noted that it is possible that the quality of response returned by the machine learning model may depend on how well-crafted the prompt is. In some embodiments, the user interface 106a may also provide one or more pre-generated user prompts for selection by the user. For example, the pre-generated user prompts may include one or more previous user prompts that were utilized by the user previously (e.g., and/or frequently).

Further, the user interface 106a may also display schema requirements information for the user to view (e.g., “See required elements from schema here”). More specifically, the schema requirements information may include information regarding an API schema corresponding to the API selected by the user. For example, the user may be required to specify particular elements in the user prompt, in which failure to specify such particular elements may prevent generating of a data object. As such, the schema requirements information may assist the user in generating a user prompt.

Moreover, the user interface 106a also includes a “Generate Data Object” button, which allows the user to generate a data object when activated (e.g., the user may activate this button after inputting the information (e.g., API, URL context, web method, prompt, etc.) as user instruction). In some embodiments, in the case that the user fails to input one or more information (e.g., API, URL context, web method, prompt, etc.) in the user instructions, the user interface 106a may display an error message. It should be noted that the data object generated may correspond to a header and/or payload in the API request. The header may include information regarding the API request itself. For example, the header may include metadata about what the client is requesting and how the client expects the server to respond (e.g., the header may specify the format of the payload). The payload may include the data that is being transmitted to the server. For example, the payload may include the information from the user prompt in a particular format that is acceptable by the API.

At block 206, the data retrieval module 106b retrieves an API schema specified in the user instructions from the API schema database 110 (e.g., as shown in FIG. 3, the user specified “Brokerage Order Entry V1.0” as the API in the user instructions). As discussed previously, an API schema may include documentation that describes the structure or format of data that are exchanged between the requesting application (e.g., a client) and the response application (e.g., a server). More specifically, the API schema specifies rules for how requests and/or responses are to be formatted, expected data types, and any constraints on the data. For example, the API schema may outline the structure of the data being sent and received (e.g., in formats such as JavaScript Object Notation (JSON), Extensible Markup Language (XML), Yet Another Markup Language (YAML), or Web Service Description Language (WSDL), etc.).

In another example, the API schema may indicate one or more fields (or properties) within the data, the names of the fields, the data types of the fields (e.g., string, integer, Boolean, etc.), and whether the field is required or optional. In yet another example, the API schema may also indicate the expected format of requests that the clients send to the server (e.g., HTTP methods such as GET, POST, PUT, DELETE), endpoints, and any required parameters. In a further example, the API schema may also indicate the format of the response that is sent back to the client, including the HTTP status codes and the response body. In yet a further example, the API schema may also include rules for validating the data being exchanged between the client and the server, thereby ensuring the data conforms to the expected format (and/or constraints).

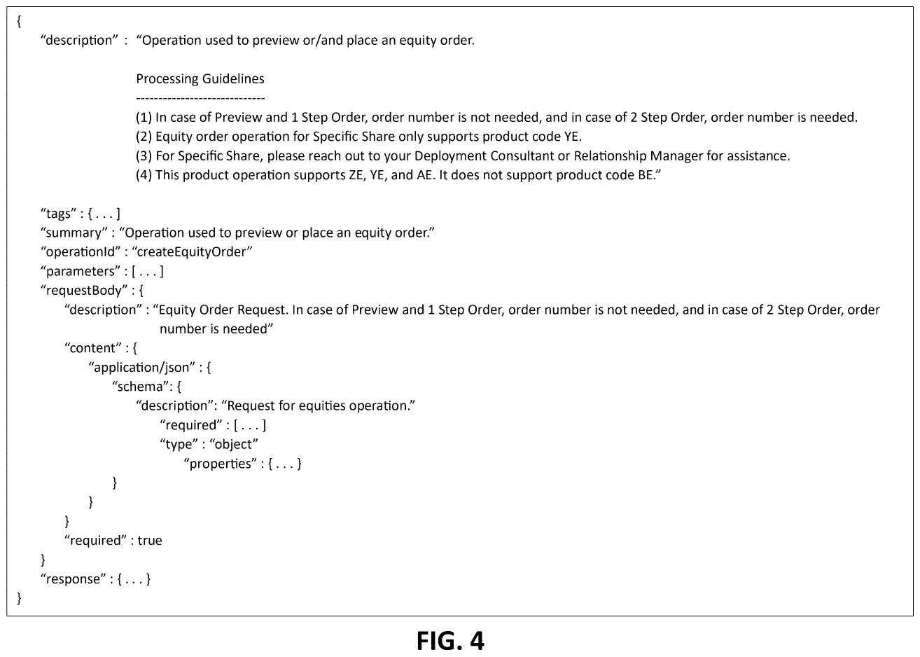

In some embodiments, the data retrieval module 106b extracts a portion of the API schema that is relevant to generating the data object according to the user prompt (e.g., the entire API schema is not used to generate the data object in the routine 200). More specifically, the data retrieval module 106b may, for example, parse through the entire document corresponding to the API schema and extract the relevant portions. Such parse and extraction may be performed by a machine learning model (e.g., language model or LLM) that is retrieved from the machine learning store 108 by the data retrieval module 106b. For example, such retrieved machine learning model may include at least one of GPT-4o (Omni), GPT-4 32 k, Claude-35 Sonnet, Claude-3 Sonnet, and Claude-3 Haiku. An example of an extracted portion of the API schema is illustrated in FIG. 4. As shown, the description of these extracted portion (“Operation used to preview or/and place an equity order.”) corresponds to the user prompt in FIG. 3 (“Create a BUY limit order for 375 Apple with limit price of 123.00 for account number ETK000094 and branch office number 070”).

In some embodiments, the data retrieval module 106b may perform dereferencing and converting with respect to specific API schemas (e.g., the dereferencing and converting process may be performed on the entire API schema or a portion of the API schema). The process of dereferencing and converting ensures that the LLM can process the data more effectively. Such dereferencing in the context of API schemas involves replacing references to definitions with the actual definitions themselves. More specifically, as discussed previously, the API schema may include documentation that describes the structure or format of data objects that are exchanged between the requesting application (e.g., a client) and the response application (e.g., a server). For example, FIG. 4 illustrates an example of a data object associated with the Open API. As shown, the data object 500 includes one or more references 500a, 500b that reference a definition 500c that is disposed (e.g., located) in another section of the documentation (e.g., a human reader may need to flip through the pages of the documentation to get to the definition 500c).

Consequently, the data retrieval module 106c may, for example, utilize an algorithm or a machine learning model (e.g., an LLM) obtained from the machine learning store 108 to analyze the API schema (e.g., Open API schema). The data retrieval module 106c then determines which data objects in the API schema include references to definitions, and then replaces such references with the actual definitions. For example, as shown in FIG. 4, the data object 500 as documented in the Open API schema includes one or more references 500a, 500b, which reference a definition. As such, the dereferencing process may involve the data retrieval module 106c replacing each of the reference lines 500a, 500b with the respective definition. In this case, both the reference lines 500a, 500b refer to the same definition 500c.

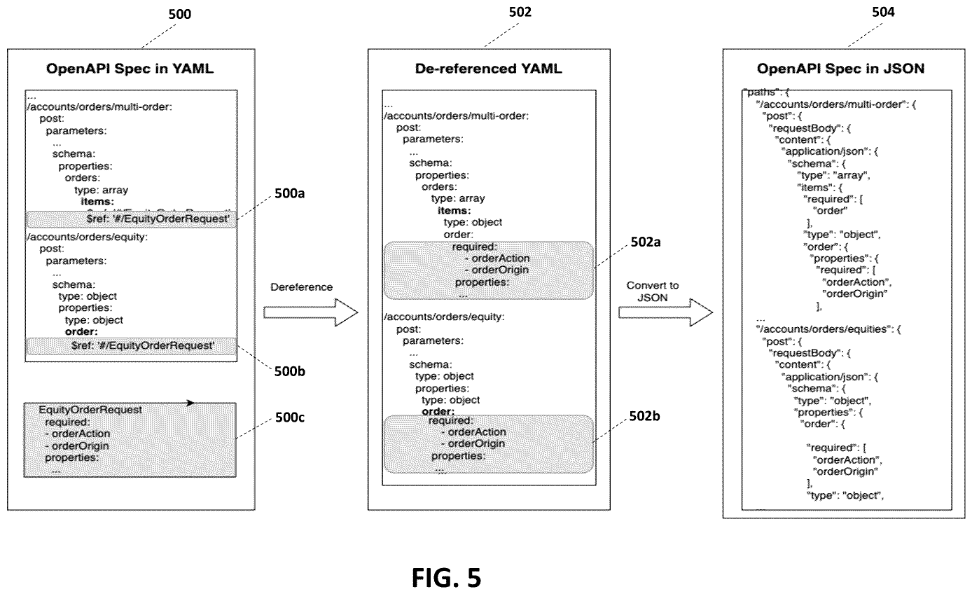

As such, the data retrieval module 106c (e.g., via the algorithm or machine learning model) replaces each of the reference lines 500a, 500b with the definition 500c. Such replacement is shown in data object 502, in which section 502a, 502b of the data object now display the actual definitions (and not just a reference to them). Next, the data retrieval module 106c converts the data object from a first format to a second format. As shown in FIG. 5, the data object 500, 502 is in the YAML format. Therefore, the data retrieval module 106c converts the data object from the YAML format to the JSON format, which results in the data object 504 being in the JSON format. An advantage of such dereferencing and conversion is that large language models (LLMs) (e.g., GPT-4o) are more efficient and accurate when processing data that is in the JSON format due to JSON being in a structured and consistent format. Consequently, the data retrieval module 106b may perform dereferencing and converting for the API schema retrieved from the API schema database 110 to generate a modified API schema.

At block 208, the data object generating module 106c determines a relevance value based on the user prompt and the API schema (e.g., retrieved by the data retrieval module 106b from the API schema database 110). The relevance value indicates whether a data object is capable of being generated based on the user prompt and the API schema. The data object generating module 106c may generate the relevance value using, for example, a sentence transformer (e.g., all-mpnet-base-v2). A sentence transformer is a type of machine learning model that encodes sentences into high-dimensional vectors (e.g., embeddings), which can then be used for various tasks such as semantic search, clustering, and sentence similarity. For example, the sentence transformer may have been trained to determine how to convert a word into an embedding, and may generate a list pairing each word to its corresponding vector equivalent.

In another example, the sentence transformer may be stored in the machine learning store 108. More specifically, the data object generating module 106c may retrieve the sentence transformer from the machine learning store 108 when the data object generating module 106c determines a relevance value. As a result, when a sentence is input into the sentence transformer, the input sentence is tokenized (e.g., broken down into individual words or tokens). Such tokenization may be performed using a tokenizer specific to the underlying transformer model. Examples of tokenizers include WordPiece (as described in Y. Wu et al., “Google's Neural Machine Translation System: Bridging the Gap between Human and Machine Translation” arXiv: 1609.08144v2 [cs. CL] 8 Oct. 2016, incorporated herein by reference) for BERT (Bidirectional Encoder Representations from Transformers) or Byte Pair Encoding (as described in “Neural Machine Translation of Rare Words with Subword Units” arXiv:1508.07909v5 [cs. CL] 10 Jun. 2016, incorporated herein by reference) for RoBERTa (A Robustly Optimized BERT Pretraining Approach).

The tokenized input sentence is then input to a transformer (machine learning) model (e.g., BERT, RoBERTa, Sentence-BERT). The transformer model processes the tokenized input sentence and generates one or more word embeddings. In other words, each token in the input sentence is associated with a vector representation (e.g., embedding). Next, a pooling operation (e.g., max pooling, mean pooling, CLS (Classification) pooling, etc.) is applied to one or more word embeddings. Such operation combines each of the word embeddings into a single fixed-sized vector that represents the input sentence (e.g., as a whole). In other words, the pooling operation generates a sentence embedding, which may be a dense vector that captures the semantic meaning of the input sentence.

Consequently, the data object generating module 106c generates a first sentence embedding corresponding to the user prompt and a second sentence embedding corresponding to the API schema selected by the user in the user instructions. Next, data object generating module 106c determines the semantic similarity between the user prompt and the API schema. An example of a technique to determine semantic similarity between words or sentences is using a measurement function (e.g., a heuristic quantification method of keyword matching), such as cosine similarity, Euclidean distance, Manhattan distance, Jaccard similarity, and Minkowski distance. Cosine similarity may be determined by performing operations on the vectors (e.g., first sentence embedding, second sentence embedding, etc.), such as by taking the division between the dot product of vectors and the product of the Euclidean norms or magnitude of each vector. The resulting cosine similarity score may range from zero to one, with a score closer to one indicating higher semantic similarity between the user prompt and the API schema, and a score closer to zero indicating lower semantic similarity between the user prompt and the API schema. Consequently, the relevance value may correspond to the numerical value determined by one of the aforementioned measurement functions (e.g., cosine similarity, Euclidean distance, Manhattan distance, Jaccard similarity, and Minkowski distance).

In the case that the relevance value does not reach a predetermined relevance threshold (block 210, no), the routine 200 moves to block 212. At block 212, the data object generating module 106c generates a (predetermined) error message for display on the user interface 106a. In other words, the user is informed that the data object cannot be generated based on the user prompt. For example, the user prompt may request an action that is unrelated to generating a data object, and therefore the relevance value should not reach the relevance threshold (e.g., User Prompt: “Please give me instructions for making a pizza”; Error Message: “The scenario provided by the user is not relevant.”). In another example, the user may request an action to generate a data object based on a specific scenario, but the API is not configured to generate such data object (e.g., as is evident by the API schema). For example, the API is used to search for an image in an archive, but the user prompt is associated with a buy order for purchasing equities (e.g., User Prompt: “Generate a sample to place an equity order to buy 100 shares of XYZ”; Error Message: “The scenario provided by the user is not relevant.”). After generating the error message, the routine 200 moves to block 224.

In the case that the relevance value does not reach a predetermined relevance threshold (block 210, yes), the routine 200 moves to block 214. At block 214, the prompt generating module 106d generates a system prompt (e.g., be in a natural language format) based on user prompt in user instructions and on the API schema (e.g., selected by the user in the user instructions). More specifically, after the data object generating module 106c determines that the relevance value reaches the predetermined relevance threshold, the data object generating module 106c may transmit an instruction or a notification to the prompt generating module 106d to cause the prompt generating module 106d to generate a system prompt.

For example, the system prompt may be generated using a system prompt template. More specifically, the prompt generating module 106d may modify the system prompt template to generate the system prompt. In some embodiments, there may be one or more section indicators that indicate how to modify the system prompt template to generate the system prompt. For example, a first section indicator may indicate that the user prompt may be inserted into a first section of the system prompt template (e.g., the first section being identified by the first section indicator). In another example, a second section indicator may indicate that the API schema may be inserted into a second section of the system prompt template (e.g., the second section being identified by the second section indicator). In some embodiments, there may be multiple system prompt templates that each correspond to a different API schema. In such case, the prompt generating module 106d may select the system prompt template that corresponds to the API schema selected by the user.

In some embodiments, the system prompt may be generated using a machine learning model. For example, the prompt generating module 106d may retrieve a machine learning model (e.g., language model or LLM) from the machine learning store 108. The machine learning model retrieved by the prompt generating module 106d may include at least one of ChatGPT-4o (Omni), ChatGPT-4 32k, Claude-35 Sonnet, Claude-3 Sonnet, and Claude-3 Haiku. In such case, the prompt generating module 106d may input at least one of the user prompt, the API schema, and the (relevant) system prompt template into the machine learning model in order to generate the system prompt. In another example, the prompt generating module 106d may input, into the machine learning model, at least one of the user prompt, the API schema, and a generating instruction prompt that instructs the machine learning model to generate a system prompt that includes instructions for generating a data object based on at least on the user prompt and the API schema.

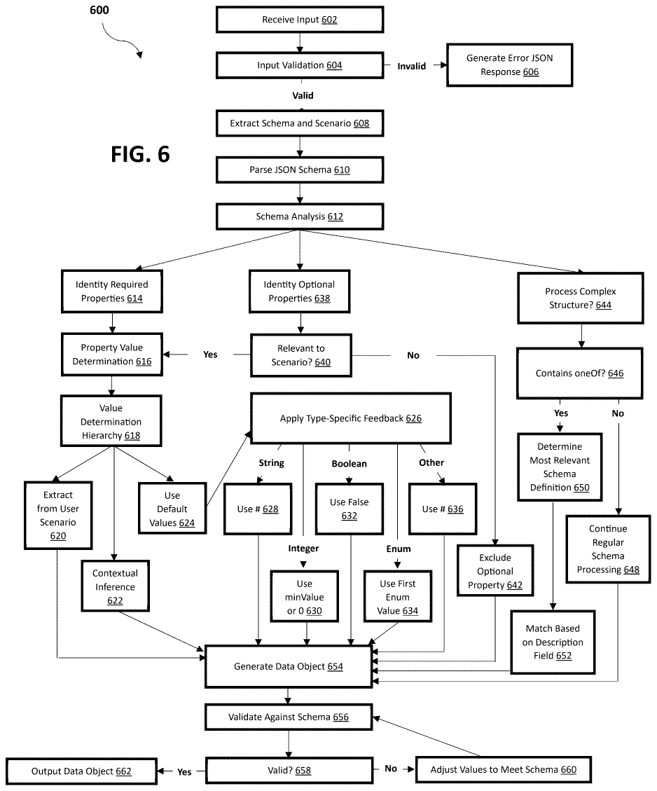

The system prompt may provide guidance (to the machine learning model) on how the machine learning model is to generate the data object. The system prompt, which is in a natural language format, may specify a procedure for a machine learning model to perform when generating the data object. An example of a process or procedure that is representative of a system prompt is shown by process 600, as shown in FIG. 6. More specifically, each block in process 600 may be an instruction that is followed by the machine learning model. The exact instructions may be written or generated in any manner, such that they correspond to one or more blocks in the process 600. In other words, for example, the process 600 may be an abstract representation of a structure of the system prompt.

At block 602, an input is received. For example, the input may correspond to the user prompt and the API schema. At block 604, a validation of the input is performed. In case that the input is invalid (block 604, invalid), the process moves to block 606, where an error JSON response is generated at block 606. On the other hand, in the case that the input is valid (block 604, valid), the process moves to block 608, where the API schema and the scenario are extracted. At block 610, the JSON schema is parsed. At block 612, a schema analysis is performed. At block 614, the required properties are identified. At block 616, the property value is determined. At block 618, the value determination hierarchy is performed. In other words, the data object may include one or more key-value pairs. The value of each key-value pair may be determined based on a hierarchy. In this case, the hierarchy prioritizes the value in the user prompt (e.g., user scenario), then the value inferred from the user prompt, and finally the default values (which is the lowest in the priority chain). At block 620, the value is extracted from user scenario. In the case that the value cannot be extracted from the user scenario, the value is determined using contextual inference at block 622.

In case that the value cannot be extracted from the user scenario and cannot be determined using contextual inference, the default values are used in block 624. At block 626, the default values are determined by applying type-specific feedback. In case that the key is a string, the default value is pound (#) symbol, as shown in block 628. In case that the key is an integer, the default value is a minimum value or zero, as shown in block 630. In case that the key is a Boolean, the default value is False, as shown in block 632. In case that the key is an enumerated type, the default value is the first of the enumerated values that the key can take, as shown in block 634. In case that the key does not fall under any of the aforementioned types, default value is a pound (#) symbol, as shown in block 634.

In addition, the schema analysis also involves identifying optional properties, as shown in block 638. At block 640, it is determined whether the optional properties are relevant to the scenario. In case that they are relevant (block 640, yes), the process 600 moves to block 616, where the value of the properties are determined. On the other hand, in case that they are not relevant to the scenario (block 640, no), the process 600 moves to block 642, where the optional properties are excluded. Moreover, the schema analysis also includes a determination of whether to process complex structures, as shown in block 644. At block 646, it is determined whether the schema includes “oneOf”. In other words, the term “oneOf” refers to the fact that the schema may provide different options for a key-value pair (e.g., equity operation, options operation) of a data object item in the data object (discussed in detail infra), in which one option is selected. In case that there is no selection to be made (i.e., no “oneOf”)(block 646, no), regular schema processing is continued, as shown in block 648. On other hand, in case that there is a selection to be made (i.e., there is a “oneOf”) (block 646, yes), the most relevant option (e.g., schema definition) is selected, as shown in block 650. Then, it is matched based on description field, at block 652).

After the blocks 620, 622, 628, 630, 632, 634, 636, 642, 648, and 652 have been processed or executed, the process 600 moves to block 654. At block 654, the data object is generated. Then, at block 656, the data object is validated against the API schema. In case that the data object is determined to be invalid in view of the schema (block 658, no), the process 600 moves to block 660. At block 660, the values (e.g., in the key value pair) of the data object is adjusted to conform to (or meet) the schema. Then, after block 660, the process 600 moves to back block 656, where the schema validation is performed again. On the other hand, in case that the data object is determined to be valid in view of the schema (block 658, yes), the process 600 moves to block 662. At block 662, the data object is outputted.

At block 216, the data object generating module 106c generates the data object. More specifically, after the prompt generating module 106d has generated the system prompt (e.g., by modifying the system prompt template to include the user prompt and the API schema), the data object generating module 106c may retrieve a machine learning model (e.g., language model or LLM) from the machine learning store 108. The machine learning model retrieved by the data object generating module 106c may include at least one of GPT-4o (Omni), GPT-4 32 k, Claude-35 Sonnet, Claude-3 Sonnet, and Claude-3 Haiku. Then the data object generating module 106c may input the system prompt (that is generated based on the system prompt template) into the machine learning model. In response, the machine learning model generates the data object based on the instructions in the system prompt.

The data object may include one or more data object items. For example, each of the data object items may be in the format of a key-value pair. In some embodiments, as discussed previously, the data object may correspond to an API request that is formatted according to Hypertext Transfer Protocol (HTTP), in which the API request includes at least one of a uniform resource locator (URL), an HTTP (or web) method, a header, and a body. For example, the data object may correspond to the header and the body of the API request. As discussed previously, the data object may include instructions for facilitating at least one of the retrieval of data from or the execution of one or more tasks on a server computing device.

After generating the data object, the data object generating module 106c determines whether the machine learning model has failed to generate values for one or more data object items, at block 218. For example, as discussed previously, the one or more data object items may be a key-value pair. As such, there may be one or more keys of the key-value pair that lack a corresponding value. In case that the data object generating module 106c determines that the machine learning model has failed to generate one or more values for the data object items (block 218, yes), the routine 200 moves to block 220.

At block 220, the data object generating module 106c generates default values for each of the one or more data object items that lack a corresponding value. More specifically, the data object generating module 106c may generate such default values based on one or more predetermined rules. For example, for a first predetermined rule, in a case that the specific data object item includes a data type of integer, then the default value is zero (i.e., 0). For a second predetermined rule, in a case that the specific data object item includes a type of Boolean data type, then the default value is false. For a third predetermined rule, in a case that the specific data object item includes any other data type, the default value is a string data type having the pound (#) character.

In some embodiments, the data object generating module 106c uses one or more rules or algorithms to generate the default values. In other embodiments, the data object generating module 106c uses a machine learning model (e.g., language model or LLM) to generate the default values. For example, the data object generating module 106c may retrieve machine learning models such as, but not limited to, GPT-4o (Omni), GPT-4 32 k, Claude-35 Sonnet, Claude-3 Sonnet, and Claude-3 Haiku. In some embodiments, the data object generating module 106 may uses the machine learning model to parse through the API schema to identify one or more default values (e.g., that are recommended in the schema). In case that the data object generating module 106 (via the machine learning model) is able to identify one or more default values indicated in the API schema, the data object generating module 106 uses such default values for the corresponding data object items.

In some embodiments, the default values identified in the API schema are prioritized over default values generated using the aforementioned one or more predetermined rules (e.g., the default values identified in the API schema are used instead of the one or more predetermined rules). In case that one or more default values were not identified in the API schema, the one or more default values are generated using the aforementioned one or more predetermined rules. Consequently, a data object may include a first set of data object items having default values generated from the one or more predetermined rules and a second set of data object items having default values generated via the API schema). In case that the data object generating module 106c determines that the machine learning model has not failed to generate one or more values for the data object items (block 218, no), the routine 200 moves to block 222.

At block 222, the schema validation module 106e performs schema validation. More specifically, the data object generating module 106c may transmit the data object to the schema validation module 106e after, for example, the data object generating module 106c determines that it has not failed to generate one or more values for the data object in block 218 of routine 200 or has generated the default values for the data object in block 220 of routine 200. After receiving the data object, the schema validation module 106e may determine whether the generated data object conforms to the API schema that was used to generate the data object. It should be noted that such determination may be a rules-based validation. Rule-based validation may be deterministic (e.g., provides precise and predictable results). In other words, provided a specific input, the output of a rule-based validation results may always be the same. This is crucial for schema validation, where exact compliance with the API schema prevents errors. In addition, performing rules-based validation is more efficient in terms of computational resources and speed, since such rules-based validation is configured to quickly parse and validate data objects against a predefined schema. In some embodiments, in case that the schema validation has failed, the user is informed that an error has occurred via, for example, user interface module 106a. In some embodiments, in case that the schema validation has passed (e.g., not failed), the schema validation module 106e transmits a notification to the data object generating module 106c, in which the notification indicates that the data object has passed schema validation (e.g., the schema of the data object has been validated).

For example, in the case that the API schema used to generate the data object is Open API (in which the documents are in JSON format), the schema validation module 106e may utilize a JSON parser (e.g., in Python programming language). More specifically, the data object generating module 106c first determines a specific endpoint (e.g., URL) and a web method (e.g., GET, POST, PUT, DELETE, etc.) in the Open API schema (e.g., Open API document) by, for example, identifying the “paths” object and then determining the corresponding web method. Once the endpoint and web method are located, the schema validation module 106e extracts the request schemas, which may be defined under the “requestBody.” The JSONschema function may be used to determine whether the data object adheres or conforms to the structure, data types, required fields, and other constraints defined in the JSON schema.

For example, in the case that the API schema used to generate the data object is SOAP (in which the documents are in the WSDL (Web Services Description Language) format, which is XML-based (Extensible Markup Language)), the schema validation module 106e may utilize a lxml to parse the WSDL to determine the specified operation. Such determination can be performed by, for example, identifying the ‘portType’ and ‘binding’ elements to determine the operation and the corresponding input and output messages. The input references XML schema types that are defined in the ‘types’ section of the WSDL. Such XML schema types are then extracted for validation. The generated data object (associated with the SOAP API) may then be checked to determine whether such data object adheres (e.g., conforms) to the structure, data types, required elements, and other constraints defined in the XML schema.

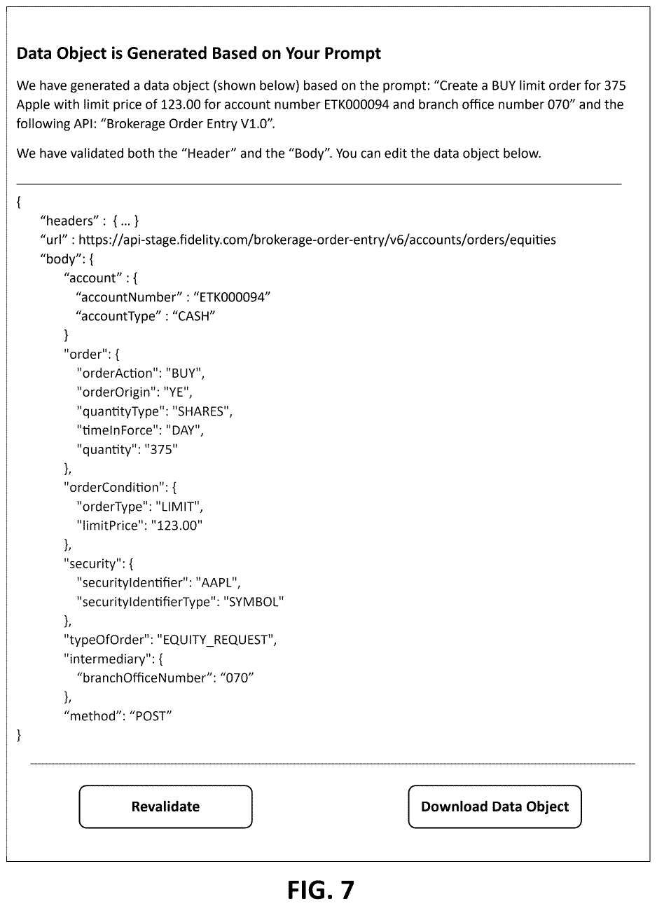

At block 222, the user interface 106a displays the data object before the user. More specifically, after schema validation has been performed, the data object generating module 106c may transmit the data object to be displayed on the user interface 106a. For example, the user interface 106a may generate a user interface screen that is displayed before the user, as illustrated in FIG. 7. As shown, the user interface screen informs the user that the data object has been generated based on the user prompt (e.g., “Create a BUY limit order for 375 Apple with limit price of 123.00 for account number ETK000094 and branch office number 070”) and the API (e.g., “Brokerage Order Entry V1.0”) both provided by the user. In addition, the user has been informed that the schema validation has been performed, such that the data object adheres (e.g., conforms) to the structure, data types, required elements, and other constraints defined in the API schema (e.g., “We have validated both the ‘Header’ and the ‘Body’ ”). As discussed previously, it is possible that the schema validation may have failed, and therefore the user is informed that an error has occurred schema (e.g., “The schema validation failed with respect to one of the ‘Header’ and the ‘Body’”).

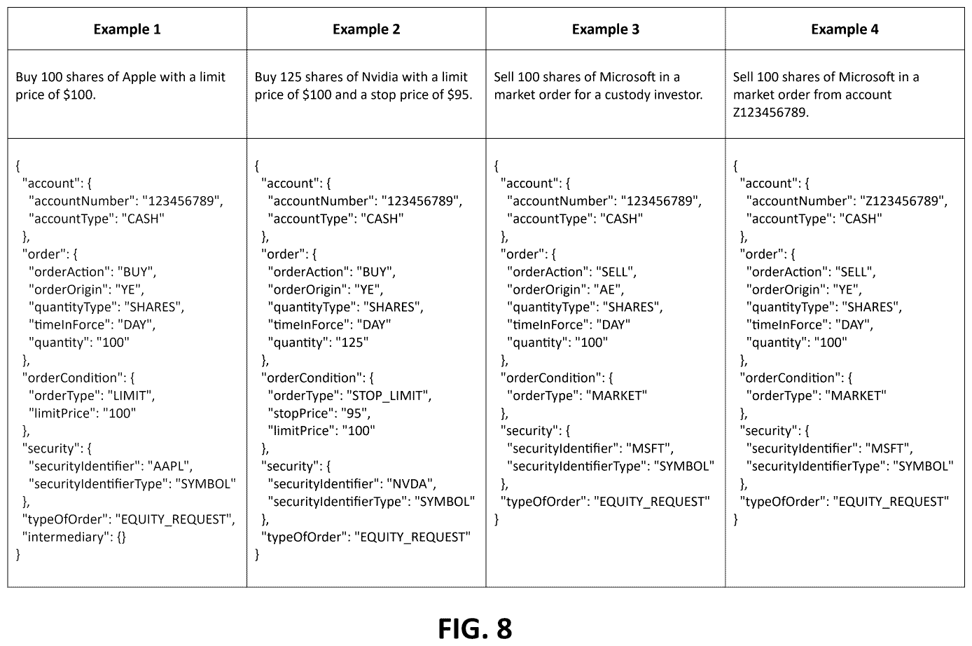

The data object is also shown to the user in the user interface screen. As discussed previously, the data object may correspond to an API request that is formatted according to Hypertext Transfer Protocol (HTTP), in which the API request includes at least one of a uniform resource locator (URL), an HTTP (or web) method, a header, and a body (e.g., header and/or body may constitute a payload). In such a case, the data object may correspond to the header and the body of the API request. As discussed previously, the data object may include instructions for facilitating at least one of the retrieval of data from or the execution of one or more tasks on a server computing device. An example of additional data objects is illustrated in FIG. 8. As shown, each data object is shown with a corresponding user prompt (e.g., that was used to generate the data object). Further, one or more portions of the data object may remain the same among the illustrated examples (e.g., example 1, example 2, example 3, example 4). For example, both example 1 and example 2 indicate a buy order. Therefore, the key “orderAction” shows “BUY”. Likewise, one or more portions of the data object may be different among the illustrated examples (e.g., example 1, example 2, example 3, example 4). For example, both example 1 and example 2 indicate a different stock (e.g., Apple, Nvidia, Microsoft). Therefore, the key “securityIdentifier” is AAPL for example 1, NVDA for example 2, and MSFT for example 3.

The user may also be informed that the user may be permitted to edit the data object (“You can edit the data object below”). As shown below, the data object includes one or more data object items in the form of key-value pairs. For example, the keys may include, but is not limited to, “accountNumber”, “accountType”, “orderAction”, “orderOrigin”, “quantity”, “securityIdentifier”, “typeOfOrder”, “branchOfficeNumber”, etc. For example, the values may include, but is not limited to, “ETK000094”, “CASH”, “BUY”, “YE”, “375”, “AAPL”, “SYMBOL”, “EQUITY_REQUEST”, “070”, etc. In some embodiments, each of the keys in the key-value pairs are unmodifiable. In some embodiments, each of the values in the key-value pairs are modifiable by the user. Further, in a case that the user has edited the data object, the user may perform revalidation. In other words, the edited data object may not always conform to the API schema (e.g., accidentally due to human error), Therefore, the user may activate the “Revalidate” button in order to perform schema validation (e.g., again). The schema validation is the same as before, in which the API schema corresponding to the data object determines how the schema validation is to be performed. As discussed previously, the schema validation module 106e may perform the schema validation.

Moreover, the user is also provided with the option to download the data object via the “Download Data Object” button. In other words, when the user activates the “Download Data Object” button, the data object may downloaded as a file (e.g., text file) to the user's device (e.g., client computing device 102). Further, as discussed previously, the API request may be formatted according to the Hypertext Transfer Protocol (HTTP), in which the API request includes at least one of a uniform resource locator (URL), an HTTP (or web) method, a header, a body (e.g., the data object may correspond to the header and the body of the API request), and other necessary components (e.g., that complete the API request). Therefore, in some embodiments, when downloading the generated data object, the user may also have the option of downloading the entire API request (including the data object), which may be generated by the data object generating module 106c. The entire API request may be a complete API request that can work in real-world practical application (e.g., is deployed in a live environment to a server).

In some embodiments, after generating the data object, the user may wish to test the generated API request. Common application tools for testing an API request include Postman and Insomnia, which both support the same format for “collection” files (e.g., files which define a project that can be imported to and exported from the Postman and Insomnia applications). As such, the user also has the option of having the data object converted into a format associated with the Postman and Insomnia tools. For example, in case that the data object is in the JSON format, the data object generating module 106c may convert such data object from the JSON format into a Postman or Insomnia format (e.g., a collection file), which users can import into the Postman or Insomnia applications on their device (e.g., client computing device 102) and begin testing the request to the web service. The routine ends at block 224.

It should also be noted that the aforementioned process described in routine 200 has advantages over conventional methods that involve utilizing retrieval-augmented generation (RAG). First, the process in routine 200 provides greater accuracy. By utilizing schema extraction directly from the API schema ensures that the schema validation is up-to-date and accurate. In contrast, RAG relies on semantic matching and retrieving relevant documents (e.g., documents other than the API schema) or snippets, which may not always be perfectly aligned with the current API schema. Further, the process in routine 200 provides reduced ambiguity. By focusing on a specific endpoint (e.g., URL) and web method, ambiguity, that can arise from retrieving and interpreting multiple related documents or examples, can be eliminated. In addition, there is reduced overhead. In the process of routine 200, schema extraction and validation involves a straightforward process of parsing the API schema (e.g., documentation) and validating the generated message. RAG, on the other hand, involves additional steps of retrieving, ranking, and integrating relevant information, which can introduce complexity and computational overhead. Moreover, there is lower computation cost. In the process of routine 200, schema extraction and validation are computationally efficient operations. RAG requires maintaining and querying a large corpus of documents in vector database, which can be resource-intensive, especially for large-scale applications.

### Execution Environment

FIG. 9 illustrates various components of an example computing device 900 configured to implement various functionality described herein.

In some embodiments, the computing device 900 may be implemented using any of a variety of computing devices, such as server computing devices, desktop computing devices, personal computing devices, mobile computing devices, mainframe computing devices, midrange computing devices, host computing devices, or some combination thereof.

In some embodiments, the features and services provide by the computing device 900 may be implemented as webs services consumable via one or more communication networks. In further embodiments, the computing device 900 is provided by one or more virtual machines implemented in a hosted computing environment. The hosted computing environment may include one or more rapidly provisioned and released computing resources such as computing devices, networking devices, and/or storage devices. A hosted computing environment may also be referred to as a “cloud” computing environment.

In some embodiments, as shown, a computing device 900 may include one or more processors 902, such as physical central processing units (“CPUs”); one or more network interfaces 904, such as network interface cards (“NICs”); one or more computer readable medium drives 906, such as a high density disk (“HDDs”), solid state drives (“SSDs”), flash drives, and/or other persistent computer readable media; one or more input/output drive interfaces 908; and one or more computer-readable memories 910, such as random access memory (“RAM”) and/or other volatile non-transitory readable media. The one or more computer-readable memories 910 may include computer program instructions that one or more computer processors 902 execute and/or data that the one or more computer processors 902 use in order to implement one or more embodiment. For example, the one or more computer-readable memories 910 can store an operating system 912 to provide general administration of the computing device 900.

As another example, the one or more computer-readable memories 910 can store a user interface module 914 (e.g., user interface module 106a) for receiving input from the user and displaying output (e.g., data object) to the user. In yet another example, the one or more computer-readable memories 910 can store a data retrieval module 916 (e.g., data retrieval module 106b) for retrieving API schema from an API schema database (e.g., API schema database 110), for modifying (e.g., converting) the API schema, and for extraction portions of the API schema. In a further example, the one or more computer-readable memories 910 can store a data object generating module 918 (e.g., data object generating module 106c) for generating data objects. In yet a further example, the one or more computer-readable memories 910 can store a prompt generating module 920 (e.g., prompt generating module 106d) for generating system prompts. In another example, the one or more computer-readable memories 910 can store a schema validation module 922 (e.g., schema validation module 106e) for performing schema validation on data objects. In yet another example, the one or more computer-readable memories 910 can store machine learning model(s) 924 (e.g., machine learning store 108) that may store machine learning models as well as (large) language models for processing natural language input and generating natural language output.

### Terminology

The term “model,” as used in the present disclosure, can include computer-based models of any type and of any level of complexity, such as any type of sequential, functional, or concurrent model. Models can further include various types of computation models, such as, for example, artificial neural networks (“NN”), language models (e.g., large language models (“LLMs”)), artificial intelligence (“AI”) models, machine learning (“ML”) models, multimodals (e.g., models or combinations of models that can accept inputs of multiple modalities, such as images and text), and/or the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language response based on the text on which the model is trained. A language model may include n-gram, exponential, positional, neural network, and/or other types of models.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise an NN trained using self-supervised learning. An LLM may be of any type, including a Question Answer (“QA”) LLM that may be optimized for generating answers from a context, a multimodel LLM/model, and/or the like. An LLM (and/or other models of the present disclosure), may include, for example, attention-based and/or transformer architecture or functionality.

While certain aspects and implementations are discussed herein with reference to use of a language model, LLM, and/or AI, those aspects and implementations may be performed by any other language model, LLM, AI model, generative AI model, generative model, ML model, NN, multimodel model, and/or other algorithmic process. Similarly, while certain aspects and implementations are discussed herein with reference to use of a ML model, those aspects and implementations may be performed any other AI model, generative AI model, generative model, NN, multimodel model, and/or other algorithmic processes.

In various implementations, the LLMs and/or other models (including ML models) of the present disclosure may be locally hosted, cloud managed, accessed via one or more Application Programming Interfaces (“API's”), and/or any combination of the foregoing and/or the like. Additionally, in various implementations, the LLMS and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLaMA (large Language Model Meta AI), and BigScience Large Open-science Open-access Multilingual Language Model (BLOOM).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus (e.g., a programmable processor, a computer, and/or multiple computers). A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry (e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like). Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data (e.g., magnetic, magneto-optical disks, or optical disks). A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices (e.g., DRAM, SRAM, EPROM, EEPROM, and flash memory devices); magnetic disks (e.g., internal hard disks or removable disks); magneto-optical disks; and optical disks (e.g., CD, DVD, HD-DVD, and Blu-ray disks). The processor and the memory can be supplemented by and/or incorporated in special purpose logic circuitry.

To provide for interaction with a user, the above-described techniques can be implemented on a computing device in communication with a display device (e.g., a CRT (cathode ray tube), plasma, or LCD (liquid crystal display) monitor, a mobile device display or screen, a holographic device and/or projector, for displaying information to the user and a keyboard and a pointing device (e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback (e.g., visual feedback, auditory feedback, or tactile feedback; and input from the user can be received in any form, including acoustic, speech, and/or tactile input).

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computing system for generating a sample data object that is associated with an application programming interface (API) request, the system comprising memory for storing computer-executable instructions and a processor that executes the computer-executable instructions to:
receive user instructions from a user to generate a data object associated with an API request, wherein the user instructions include a particular API associated with the API request and a user prompt, which is in a natural language format, that specifies a scenario from which to generate the data object, and wherein the data object includes instructions for facilitating at least one of the retrieval of data from or the execution of one or more tasks on a server computing device;
generate, via a first machine learning model, a relevance value based on at least one of the user prompts and an API schema, corresponding to the particular API, that is retrieved from a database, wherein the relevance value indicates whether a data object is capable of being generated based on the user prompt and the API schema;
generate a system prompt, which is in a natural language format, that specifies a procedure for a machine learning model to perform when generating the data object, wherein the system prompt is generated after determining that the relevance value reaches a predetermined relevance threshold, and wherein the system prompt is generated by modifying a system prompt template to include the user prompt and the API schema;
generate, via a second machine learning model, the data object based on the system prompt, wherein the data object includes one or more data object items, and wherein, in a case that the second machine learning model fails to generate a value for a specific data object item based on at least one of the user prompt and the API schema, the second machine learning model generates a default value for the specific data object item; and
display the data object before the user on a user interface, wherein the one or more data object items are modifiable by the user via the user interface.

2. The system of claim 1, wherein the data object items are displayed on the form as key-value pairs, wherein each of the keys in the key-value pairs are unmodifiable, and wherein each of the values in the key-value pairs are modifiable by the user.

3. The system of claim 1, wherein the schema includes at least one of JavaScript Object Notation (JSON), Yet Another Markup Language (YAML), and Web Service Description Language (WSDL).

4. The system of claim 3, wherein, in a case that the schema is JSON, the data object is converted into a Postman collection which is configured to be downloaded by the user via the user interface.

5. The system of claim 1, wherein, after the API schema is retrieved from the database, the computer executable instructions cause the processor to perform further operations to:
perform a dereferencing process in which a dereference API schema is generated from the API schema by replacing each reference line in the API schema with a corresponding definition.

6. The system of claim 5, wherein the computer executable instructions cause the processor to perform further operations to:
perform a converting process to generate a converted API schema by converting the dereference API schema from a first format to a second format, wherein the converted API schema is utilized by at least one of the first machine learning model to generate the relevance value and the second machine learning model to generate the data object.

7. The system of claim 1, wherein, in a case that the specific data object item includes a type of integer, then the default value is zero, wherein, in a case that the specific data object item includes a type of Boolean, then the default value is false, and wherein, in a case that the specific data object item includes any other type, the default value is a string having the pound (#) character.

8. A non-transitory computer-readable medium including computer-executable instructions that, when executed by a computing device, causes the computing device to:
receive user instructions from a user to generate a data object associated with an API request, wherein the user instructions include a particular API associated with the API request and a user prompt, which is in a natural language format, that specifies a scenario from which to generate the data object, and wherein the data object includes instructions for facilitating at least one of the retrieval of data from or the execution of one or more tasks on a server computing device;
generate, via a first machine learning model, a relevance value based on at least one of the user prompts and an API schema, corresponding to the particular API, that is retrieved from a database, wherein the relevance value indicates whether a data object is capable of being generated based on the user prompt and the API schema;
generate, a system prompt, which is in a natural language format, that specifies a procedure for a machine learning model to perform when generating the data object, wherein the system prompt is generated after determining that the relevance value reaches a predetermined relevance threshold, and wherein the system prompt is generated by modifying a system prompt template to include the user prompt and the API schema;
generate, via a second machine learning model, the data object based on the system prompt, wherein the data object includes one or more data object items, and wherein, in a case that the second machine learning model fails to generate a value for a specific data object item based on at least one of the user prompt and the API schema, the second machine learning model generates a default value for the specific data object item; and
display the data object before the user on a user interface, wherein the one or more data object items are modifiable by the user via the user interface.

9. The non-transitory computer-readable medium of claim 8, wherein the system prompt includes one or more examples that are associated with the schema corresponding to the particular API, and wherein the system prompt includes formatting instructions that instruct the second machine learning model to generate the data object based on a structure of the one or more examples.

10. The non-transitory computer-readable medium of claim 8, wherein the system prompt further includes one or more event instructions that guide the second machine learning model on how to handle a specific event in case that the second machine learning model encounters the specific event when generating the data object.

11. The non-transitory computer-readable medium of claim 8, wherein the system prompt further includes security instructions that instructs the second machine learning model to focus on portions of the user prompt that is relevant to the scenario and to disregard portions that are associated with system-level prompting instructions.

12. The non-transitory computer-readable medium of claim 8, wherein the system prompt further includes output instructions that instruct the second machine learning model to output the data object by itself without additional content.

13. The non-transitory computer-readable medium of claim 8, wherein, in a case that the relevance value is less than a predetermined threshold, the user is informed that the data object cannot be generated based on the user prompt.

14. The non-transitory computer-readable medium of claim 8, wherein the data object is validated based on the API schema, and wherein, in a case that the data object fails to conform to a framework of the API schema, the user is informed, via the user interface, that an error has occurred.

15. A computerized method for generating a sample data object that is associated with an application programming interface (API) request, the method comprising:
receiving user instructions from a user to generate a data object associated with an API request, wherein the user instructions include a particular API associated with the API request and a user prompt, which is in a natural language format, that specifies a scenario from which to generate the data object, and wherein the data object includes instructions for facilitating at least one of the retrieval of data from or the execution of one or more tasks on a server computing device;
generating, via a first machine learning model, a relevance value based on at least one of the user prompts and an API schema, corresponding to the particular API, that is retrieved from a database, wherein the relevance value indicates whether a data object is capable of being generated based on the user prompt and the API schema;
generating a system prompt, which is in a natural language format, that specifies a procedure for a machine learning model to perform when generating the data object, wherein the system prompt is generated after determining that the relevance value reaches a predetermined relevance threshold, and wherein the system prompt is generated by modifying a system prompt template to include the user prompt and the API schema;
generating, via a second machine learning model, the data object based on the system prompt, wherein the data object includes one or more data object items, and wherein, in a case that the second machine learning model fails to generate a value for a specific data object item based on at least one of the user prompt and the API schema, the second machine learning model generates a default value for the specific data object item; and
displaying the data object before the user on a user interface, wherein the one or more data object items are modifiable by the user via the user interface.

16. The computerized method of claim 15, wherein the API request is formatted according to Hypertext Transfer Protocol (HTTP), in which the API request includes a uniform resource locator (URL), an HTTP method, a header, and a body.

17. The computerized method of claim 16, wherein the HTTP method includes at least one of GET, POST, PUT, and DELETE, and wherein the data object is a payload within the header or body of the API request.

18. The computerized method of claim 16, wherein the user instructions specify a particular URL that corresponds to an endpoint of the API request and a particular HTTP method, and wherein the system prompt includes the particular URL and the particular HTTP method.

19. The computerized method of claim 15, wherein the first machine learning model or the second machine learning model, is at least one of a language model and a large language model (LLM).

20. The computerized method of claim 15, wherein, in a case that the first machine learning model or the second machine learning model, is an LLM, the first machine learning model or the second machine learning model includes at least one of GPT-4o (Omni), GPT-4 32k, Claude-35 Sonnet, Claude-3 Sonnet, and Claude-3 Haiku.
